(19) United States
(12) Patent Application Publication
(10) Pub. No.: US 2011/0226037 A1
(43) Pub. Date: Sep. 22, 2011

(54) Vehicle occupant support testing methodology - assessment of both the car and the restraint

(76) Inventors: Arjuna Indraeswaran Rajasingham, Bethesda, MD (US); Priyaranjan Prasad, Plymouth, MI (US); Yoganand Ghati, Chester Springs, PA (US); Daouda Adama Kone, Parkville, MD (US)

(21) Appl. No.: 12/930,531

(22) Filed: Jan. 10, 2011

Related U.S. Application Data
(60) Provisional application No. 61/335,573, filed on Jan. 9, 2010.

(51) Int. Cl. G01N 3/30

(52) U.S. Cl. 73/12.01

(57) ABSTRACT

Robust testing method for combinations of cars and child restraints for the protection of children in vehicles.

### CROSS REFERENCE TO RELATED APPLICATIONS

This application claims priority from and hereby incorporates herein by reference, 61/335,573.

### STATEMENT REGARDING FEDERALLY SPONSORED RESEARCH OR DEVELOPMENT

Not Applicable

### REFERENCE TO A MICRO FICHE APPENDIX

Not Applicable.

### FIELD OF INVENTION

Testing occupant supports in vehicles.

### BACKGROUND OF INVENTION

The design of effective protective mechanisms for children in cars has design degrees of freedom in the car design and design degrees of freedom in the child restraint system (CRS). Therefore any testing methiodology needs to allow the design flexibility for these two key elements of the protection system to identify and classify different combinations of CRS and car designs.

Child protection strategies to date, have focussed on the CRS without consideration of critical aspects of the vehicle dynamic and design and the position of the CRS in the vehicle.

The use of CRS has been implemented in some countries and the number of serious injury to the child has decreased during the last 20 years. However, there are still many risks for a child even in a CRS, even more so in near side impact situations. Several researchers have assessed these risks and injury to the head, neck and chest are still very common and serious. Many different CRS exist in the market and most of them have been through the current testing methods that are available in several countries.

A brief review/summary of the current testing methods used to assess the performance of CRS can be used as a stepping-stone for an understanding of the advantages and deficiencies in the current state of testing methods.

While it would be ideal to crash cars with each o several CRS designs, such an approach may not be economically acceptable. Therefore Sled Tests have been developed to replicate or emulate the conditions of the car crash conditions. In such Sled test, the input parameters in most methods are agreed upon with very little variation across the different tests. An international standard is in the works to provide an ISO side impact test procedure (ISO/TC 22/SC12/WG1).

A Sled testing method should be able to reproduce the crash characteristics of a real world accident. In a simple setup, that is both reproducible and repeatable, these input parameters are implemented from data such as target vehicle acceleration, velocity at the time of bullet vehicle or surrogate makes contact, intrusion velocities and related depths and times. Another important part of the setup is the geometrical representation of the Sled setup in respect to the vehicle interior and the CRS. Therefore, the Sled test must be capable of simulation real world occupant kinematics and have realistic loading condition to the CRS and dummy.

### Existing Test Methods

As mentioned earlier there are many sled test methods that have been proposed. Table 1/FIG. 1 provides the summary of the test methods proposed or currently in use in different parts of the world. Each of these tests is then further discussed in detail.

### Australian Test Methods

Australian standard AS/NZS 1754 test procedure is made of two different tests with and without fixed doors. In both teststhe doors are mounted at 90° on a test bench (FIG. 2). The centerline position of the CRS with respect to door is 320 mm. Each test serves different purposes to complement CRS performance. The test with fixed rigid door simulates the crash on the struck side while the other test without doors simulates crashes from the far side. The CRS must pass both tests to be approved with two main criteria for each test. The CRS must retain the dummy in the seat in a far side collision and head must be retained or clear of 25 mm to door in near side. The sled is adjusted to undergo a minimum change in velocity of 20 m/s for a maximum peak acceleration of 14 to 20 G.

Another slight variation of this test is known as the Australian CREP test procedure. Test bench is mounted in 90° and 66° on sled, and 24° angle to perpendicular to include forward component or pre impact braking. The seating height of the dummy is also often adjusted in this test.

### ISO Based Test Methods

The ISO test procedure consists of two components: first the sled with a modified ECE R44 test bench at 90° angle on the sled and the second is a hinged door concept placed on test bench (FIG. 3). The hinged line of the door panel is perpendicular to the seat cushion, with a 15° angle for the hinge with respect to the ground (FIG. 3). The centerline position of the CRS with respect to the hinged door is 300 mm. In order to better replicate the maximum intrusion, curved and shaped panels were used. A double shaped panel was selected for this test. The test should achieve an intrusion depth of 250 mm for a linear intrusion velocity of 7 to 10 m/s. The sled deceleration delta-v is 25 km/h for a peak sled acceleration of 10-15G. The hinged door provides a rotational intrusion of 13 rad/s on a RF CRS transferred from the translation intrusion of 12 m/s. This test also replicates the worst-case conditions with maximum intrusion closer to the head of the dummy. The door panel height is estimated at 500 mm.

The ISO working committee disapproved the draft standard for this test mainly due to missing validation for FF CRS and reproducibility. Further work on this standard suggests that this procedure might move away from the hinged door because of its complexity. Following the main guidelines in the ISO draft, modified versions of the test were implemented at different sites.

The TNO test procedure follows an earlier version of the draft and uses a flat panel instead of the shaped panel. In addition, different padding materials are used in this case.

The TUB procedure is used as part of the NPACS program with a difference in the maximum intrusion velocity and a different hinge line orientation than that of the ISO method. The maximum intrusion velocity used was 9 to 12 m/s. Some of the other differences are single shaped panel, the thicker and softer padding material and the backrest and upper belt CRS anchorage points are allowed to move in the Y direction.

### ADAC Test Method

The ADAC test procedure takes place in a body of a Volks wagen Golf car and is mounted on a sled at 80° with a fixed door (FIG. 4). The vehicle deceleration is similar to EuroNCAP with a maximum sled deceleration of 18G and an impact speed of 28 km/h. Because of the frontal component associated with this test the head containment criterion is more difficult to pass. This test is fairly simple and reproducible however there is no intrusion simulated in this case.

### TAKATA Test Method

TAKATA's linear side impact test procedure is configured on a sled at an angle of 90° but can also include variation within 10°, 15° and 20° from lateral position to include forward components. The sled input pulse is a half sine to match a sled velocity of 20 mph. (FIG. 5). The seat velocity is at 17-18 mph and the seat initial positioning is at 250 mm from the honeycomb and the impact door is located at 150 mm from the vehicle door position. The aluminum honeycomb strikes the sliding seat first in order to control the intrusion characteristics.

### DOREL-KETTERING (DK) Test Method

The DK linear side impact test procedure is configured on a sled at an angle of 90° but can also include variation within 10°, 15° and 20° from lateral position to include forward components. The test method is identical to the Takata Method except that a deceleration Sled is used rather than the High G Sled for accelerating the Bullet Sled relative to the TargfetSled/Bench/CRS. (FIG. 6). The seat velocity is at 17-18 mph and the seat initial positioning is at 250 mm from the honeycomb and the impact door is located at 150 mm from the vehicle door position. The aluminum honeycomb strikes the sliding seat first in order to control the intrusion characteristics.

### Test Method Limitations

The current test methods, although are capable of differentiating the variation in performance of different CRS designs, they have limitations in terms of replicating the kinematics experienced by CRS in crashes. Non of the noted approaches assess the performance with regfard to the car design degrees of freedom. Moreover, the additional specific limitations for each of the test methods are provided below:

### Australian Test Method

This test method does not account for the intrusion velocity and the forward component that is commonly experienced by occupants in side impacts. In addition there is no requirement of robust injury criteria and IARV's for assessing the performance. In addition these tests are conducted with P3 ATD which has been shown to have limited biofidelity.

### ISO Test Methods

From other studies it is known that in severe lateral impacts the intrusion, especially the intrusion velocity, is the injury inducing factor. Although ISO test method address this issue with the use of hinged door for simulating intrusion, the double shaped panel causes an aggressive contact with the CRS and does not reflect the intrusion shape of lateral impact tests, while a single shaped panel does. In addition the use of fixed ISOFIX anchorages seem to cause problems and there will be an unwanted interaction of the seatbelt with the panel, when a seat with pretensioning device is used. In addition the test setup is complex and is not easily reproducible. Also the use of hinge door makes it difficult to control for the intrusion velocity and thus makes the test less repeatable. A critical shotcoming is that there is no calibration of intrusion-velocity ith regard to real world crashes.

### ADAC Test Method

This test method does not simulate intrusion which is major injury causing factor in side impacts.

### TAKATA Sled Test

Although this test method represents intrusion, the CRS does not undergo any acceleration before contact with intruding door. There are two key aspects of design in the CRS the first is for reacting to the intrusion and the second is with regard to performance on inertial loading as the vehicle is struck and the forces get to the CRS through the vehicle connections. The second of these puts the child's head in a dangerous position to receive high impact force. This is a result of the high initial acceleration of the CRS before intrusion contact. This lack of replicating the initial acceleration in the CRS before contact with the intruding door structure would not be able to differentiate the advanced designs seats that may correct the effects of the inertial loading and the out of position head situation and reduce injury. Therefore this test cannot differentiate between good and poor designs with regard to inertial loading performance.

### Dorel-Kettering (DK) Test Method

Although this test method represents intrusion, the CRS does not undergo any acceleration before contact with intruding door. There are two key aspects of design in the CRS the first is for reacting to the intrusion and the second is with regard to performance on inertial loading as the vehicle is struck and the forces get to the CRS though the vehicle connections. The second of these puts the child's head in a dangerous position to receive high impact force. This is a result of the high initial acceleration of the CRS before intrusion contact. This lack of replicating the initial acceleration in the CRS before contact with the intruding door structure would not be able to differentiate the advanced designs seats that may correct the effects of the inertial loading and the out of position head situation and reduce injury. Therefore this test cannot differentiate between good and poor designs with regard to inertial loading performance.

### SUMMARY

In recent times considerable attention has been given to the protection of children in CRS in side impact crashes as these crashes represent a significant burden on society. Although side impact crashes account for only 25% of all crashes, they represent over 40% of all the injury costs associated with automobile crashes and are responsible for 42% of the fatalities and 16% of the injuries in child occupants, age 0-8 years. In spite of this significant effect of side impact crashes on the injury outcome of children, currently, no side impact performance standard exists for evaluating the child restraints. Different manufacturers use different methods for evaluating seats in side impact mode and so the performance of these seats cannot be compared. This invention provides a robust testing methodology and apparatus for such testing of combinations of car/CRS designs that are hitherto unavailable and moreover provides a more robust and complete CRS test even with constant car parameters by combining the intrusion and inertial performance calibrated to real world crashes.

It provides a methodology and apparatus for assessing the design degrees of freedom for car manufacturers comprising:
1. Position of the CRS latch anchor positions;
2. The stiffness of the car sides;
3. The design of seat anchors and tether mounts that are enabled to have lateral motion under impact conditions to reduce intrusion injury.

And for each of these, it provides a methodology and apparatus for assessing the design degrees of freedom for CRS manufacturers comprising:
1. Intrusion impact performance;
2. Inertial Loading impact performance

### BRIEF DESCRIPTION OF DRAWINGS

Table 1/FIG. 1 provides the summary of the various side impact standards being currently used or being developed in the world for quick reference.

FIG. 2 shows the illustration of the Australian test method showing the seat and the simulated door structure

FIG. 3 shows the illustration of the ISO test method showing the testing position for rear facing and forward facing child seat testing

FIG. 4 shows the ADAC test method setup with a three year old dummy in a forward facing child safety seat.

FIG. 5 shows the illustration of the TAKATA Sled setup and its components.

FIG. 6 shows an illustration of the related Dorel-Kettering Method.

FIG. 7 shows the illustration of the degrees of design freedoms for the vehicle as well as the child safety seat.

FIG. 8 Shows the state of available side impact test methods for child safety seats confined to the region of poor testing standard and precludes the observation of value in better car design

FIG. 9 shows two of the critical degrees of design freedom for the child seat alone regardless of the design opportunities for the car.

FIG. 10 shows the side view illustration of the proposed sled design and its components. The machinery for testing angled impact is included in the illustration.

FIG. 11 shows the top view illustration of the proposed sled design and its components. The machinery for testing angled impact is included in the illustration.

FIG. 12 shows the illustration of the proposed sled design for angled impact mode.

FIGS. 13-16 shows the illustration of various stages in the operation of the proposed sled design and provides illustrations about the operation and position of various critical components of the sled.

FIG. 17 shows the Velocity vs. Displacement profiles/signatures of different vehicles that were tested in a lateral impact mode along with a profile for its average value.

FIG. 18 shows the Velocity vs. Displacement profiles/signatures of a vehicle that was tested in a lateral pole impact mode to illustrate the variation in the velocity displacement response at the onset of intrusion.

FIG. 19 shows the velocity profile obtained from the simulated model of the bullet and target sleds achieved by varying stiffness of second stage of honeycomb structure.

FIG. 20 shows the different Velocity vs. Displacement profiles obtained by varying honeycomb stiffness values.

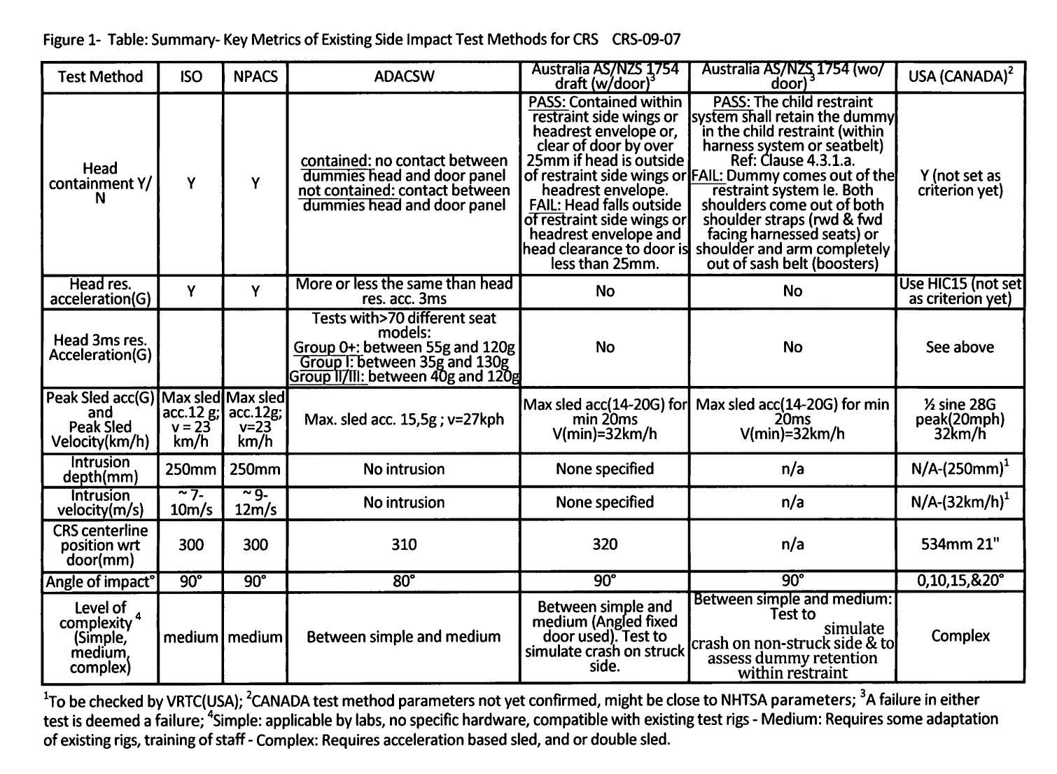

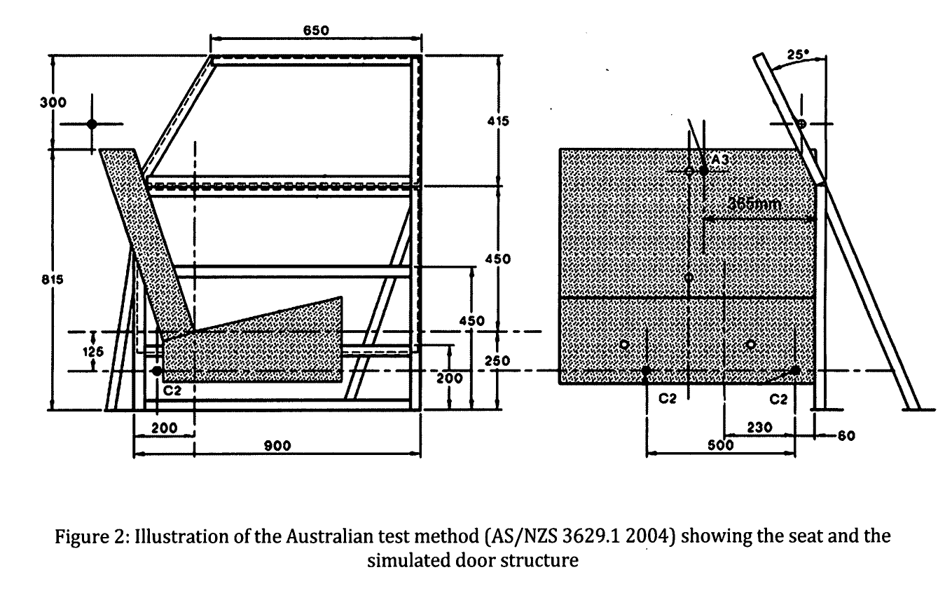

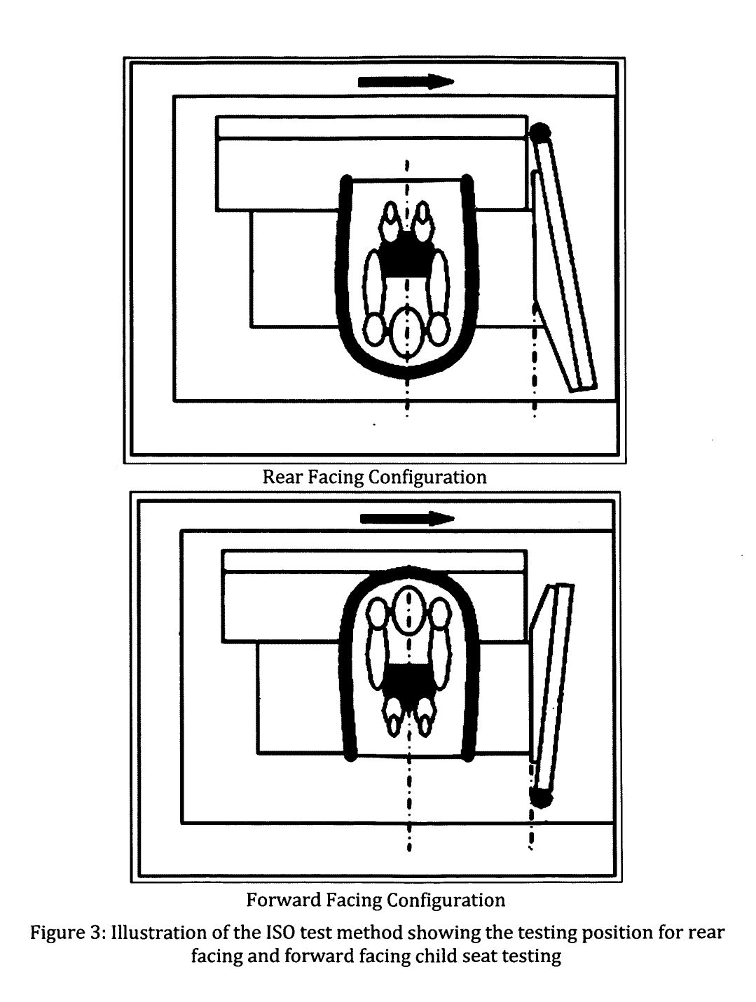

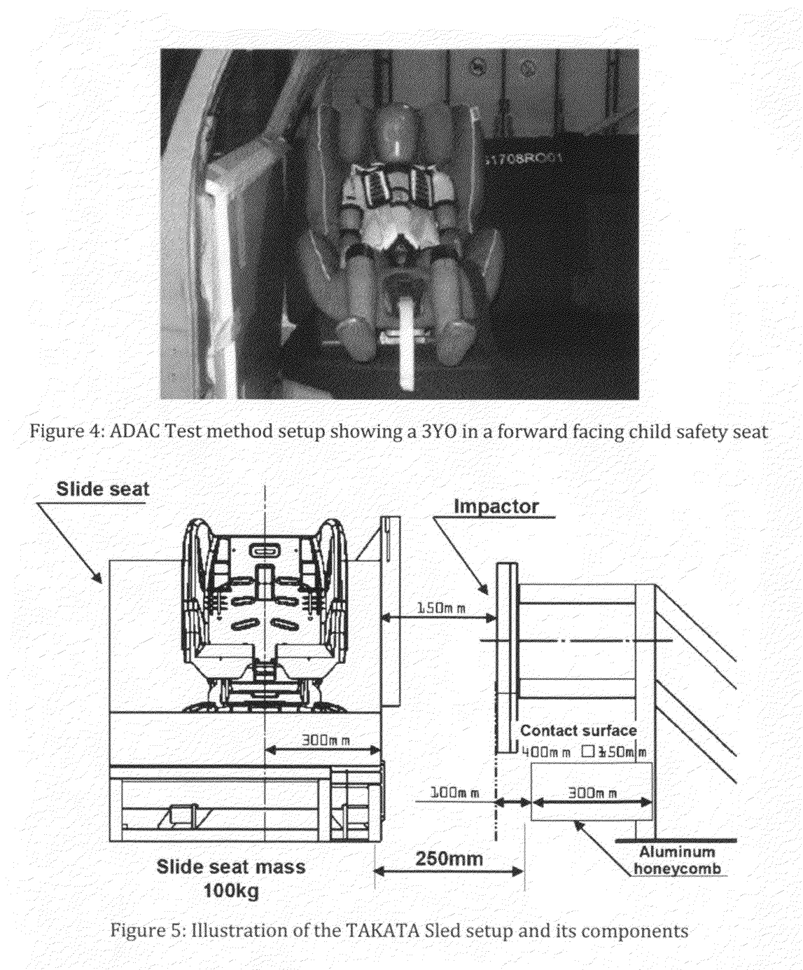

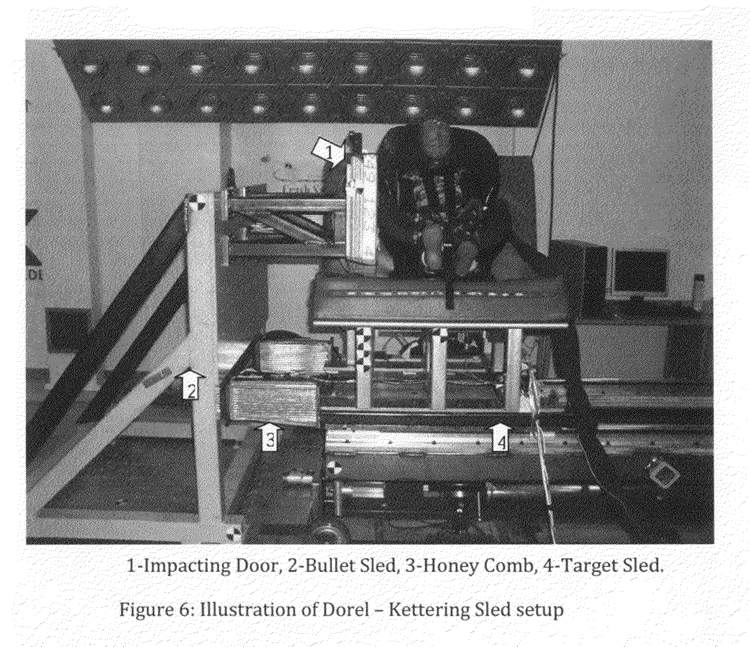

### DETAILED DESCRIPTION OF INVENTION

### Design of the Sled Test Apparatus

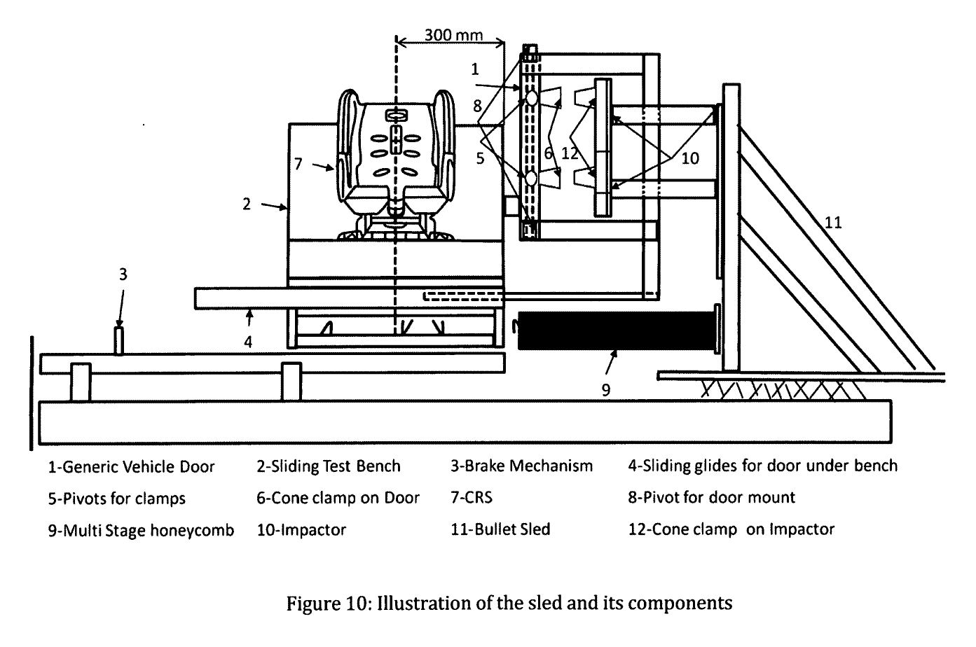

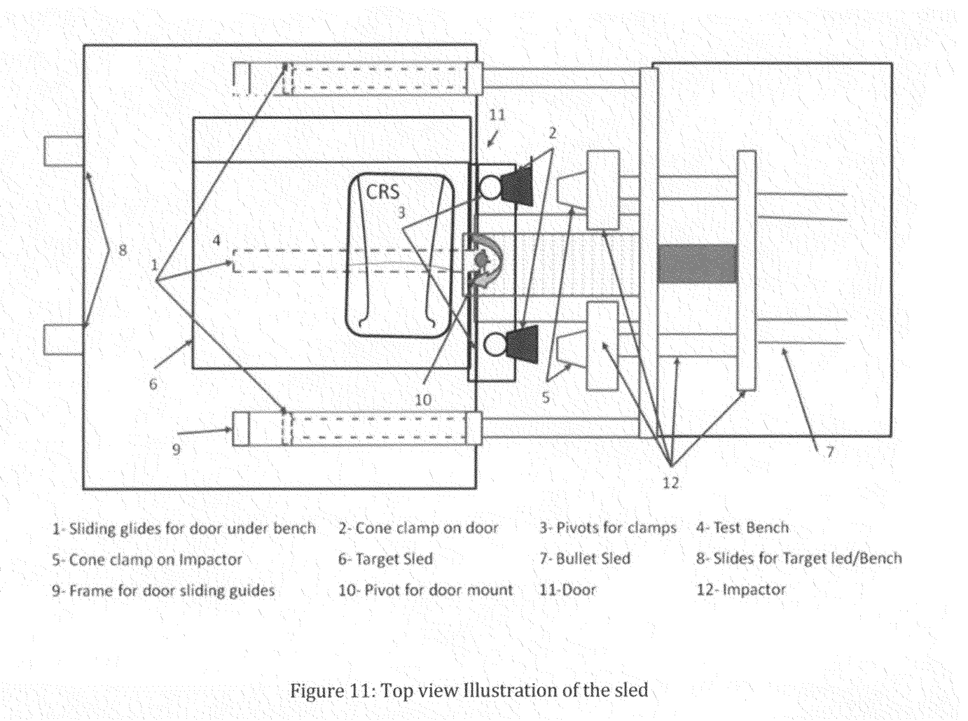

As identified earlier other studies there are two main components observed by the struck vehicle during a side impact crash: first the acceleration of the struck vehicle and secondly the intrusion of the vehicle component on the struck side. The test method is designed to perform as a comprehensive side impact test method capable of simulating vehicle side impact collisions involving child restraint systems positioned not only on the “struck (near) side” but also the non-struck (far) side of the vehicle and moreover can be used of any position in between where the car manufacturer chooses to install anchor points. More generally it is a universal test for CRS placed at any position in the vehicle relative to the struck side. The test method is repeatable, reproducible and can be easily used to develop standard procedure. The main components of the test procedure are provided in the FIG. 10, 11.

Sled test method consists of a Target Sled and a Bullet Sled. In some embodiments this may consist of a platform that accommodates for a sliding bench that is a part of the Target Sled and an impactor that is a part of the Bullet Sled. In addition there is also a Translating Door attached to the Target Sled (which in some embodiments is attached to the Bench). The Translating Door is used to emulate intrusion into the vehicle during impact. Shape of this door can be changed and defined based on the test vehicle. The forces from the Impactor are transmitted to the Target Sled/Bench through a structure made of honeycomb with several sections attached in series, each with a predefined length and stiffness. The first stage honeycomb stiffness is used to represent the initial impact and to generate the acceleration in the child seat as observed in the full vehicle tests. The length of this honeycomb section is calibrated such that it is crushed until the first desired calibration distance for intrusion is reached. The second stage honeycomb stiffness is used for obtaining the intrusion velocity and maximum intrusion value as observed in the tests. Additional stages of honey comb can be used to define further combinations of intrusion distance-intrusion velocity until the final zero intrusion velocity is reached at the maximum intrusion distance. Effectively such additional stages of honey comb will change the gradient of the intrusion-distance-Intrusion velocity profile and thereby enable the control of the test apparatus performance to better emulate the real world crashes from which data is available.

In some embodiments, the impactor impacts the bench to at about 15 m/s causing the bench to accelerate and the first stage honeycomb starts to crush. After the relative speed between the impactor and sled reaches to about 10 m/s the impactor impacts the translating door and the second stage honeycomb starts to crush and thereby controlling for the intrusion velocity and distance thereafter. The impactor and the door may be locked into each other after contact so that the door does not fly away and the effective intrusion can be controlled with the honeycomb. After the desired maximum intrusion is reached the impactor and the bench lock together. This combined unit may then be stopped using a braking mechanism to prevent further sliding.

The main components of the sled are the sliding bench, intruding generic vehicle door, honeycomb structure with multi stage stiffness, impactor with clamps, collapsible CRS attachment anchors and an optional braking mechanism to stop the sled. In addition to these components, glides for sliding bench, hinged glides for intruding door and clasping clamps for locking the impactor and the door are used. Description of each of the components and associated parts is provided below:

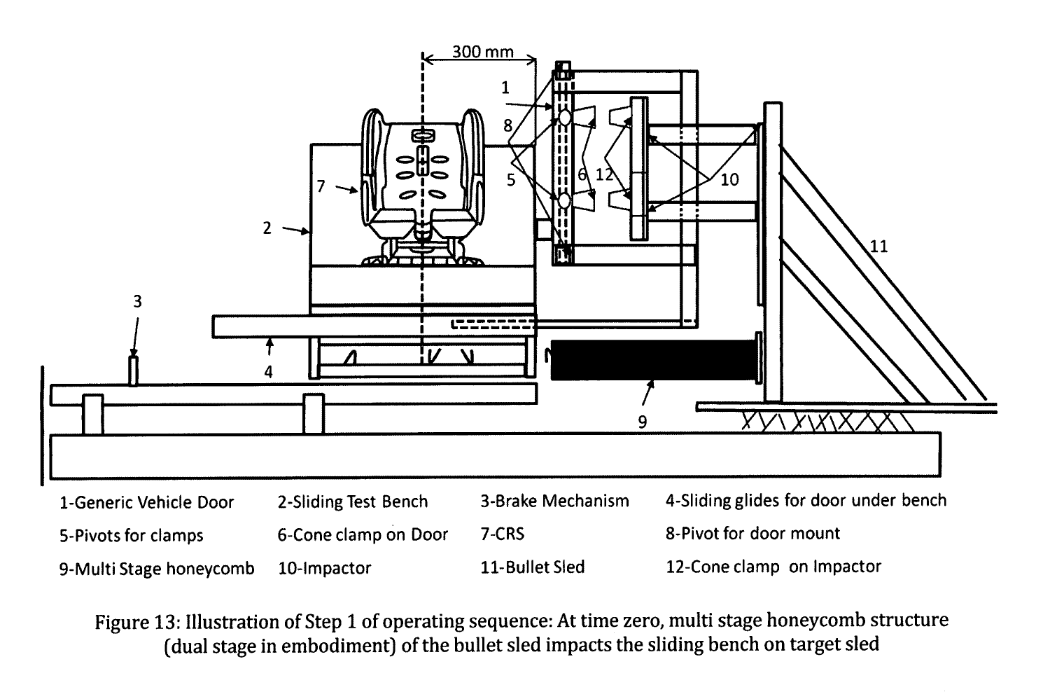

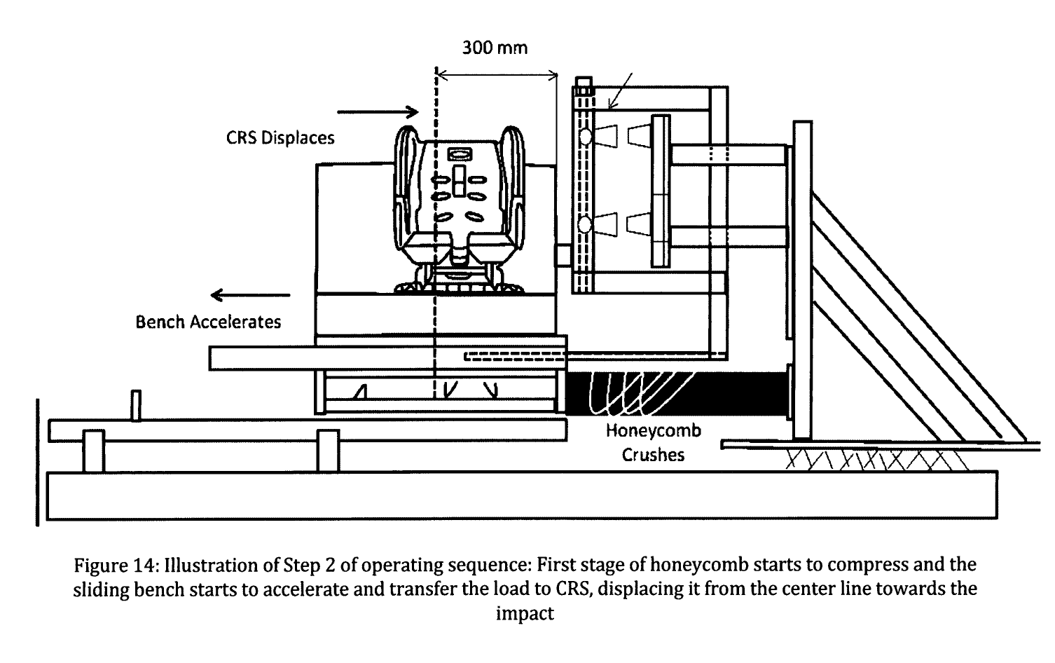

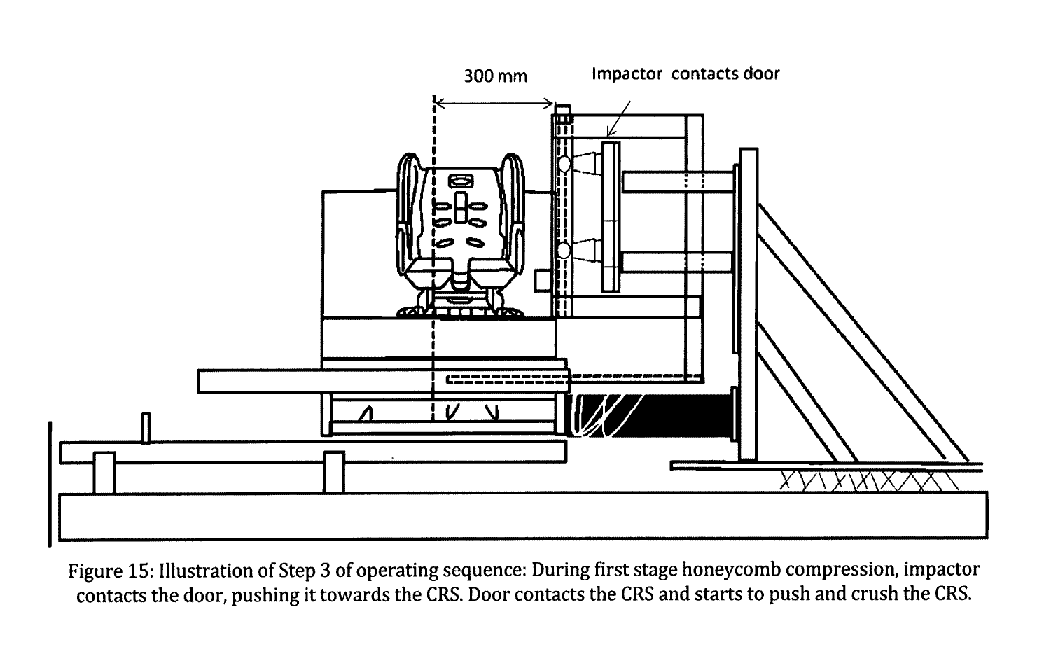

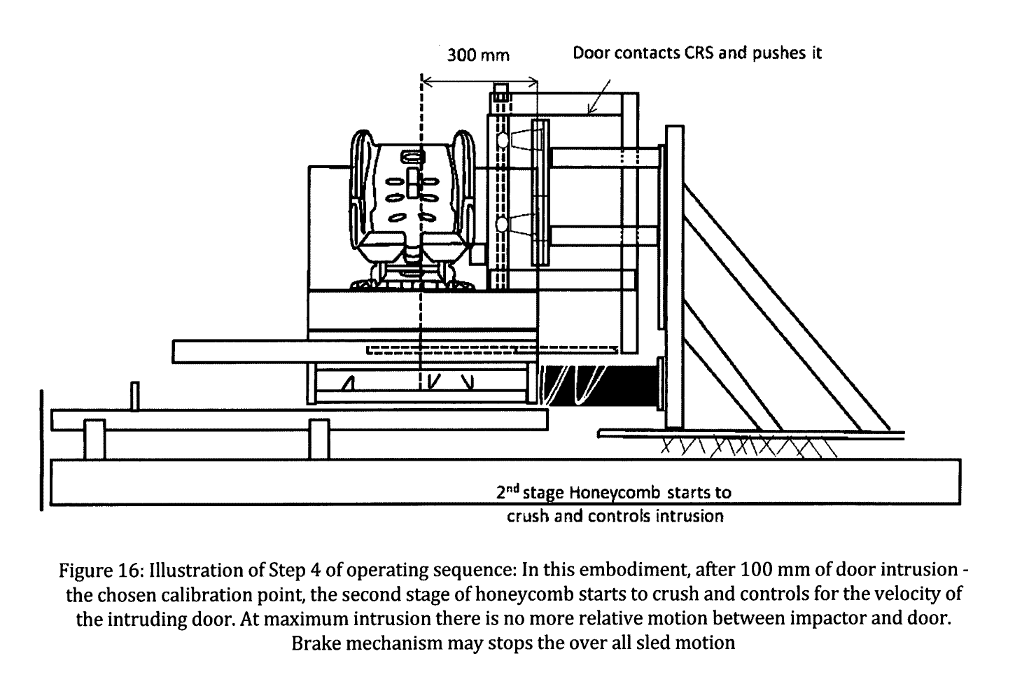

Sliding Bench: This may in some embodiment be a standard test bench/seat as defined in the Economic Commission for Europe Regulation-44 for child car seat safety standard. This bench/seat is attached to the sled through a set of glide rails which allows for the seat to translate upon transfer of force. The seat also consists of attachments for LATCH anchors so as to be able to attach CRS on to it. In addition, on the impact side of this seat a metal plate is attached, which is used for contact with the honeycomb structure on the impactor.
Impactor: This component consists of a flat surface mounted on to the sled platform with the help of a metal frame. The frame has adjustable arms that hold the impactor panel so that the impactor distance from the door can be easily modified to calibrate for the door contact point. There are connection mechanisms for attaching the Impactor to the door at the time of contact. At the bottom of the impactor frame, a honeycome structure is attached, which contacts the impact plate attached to the Target Sled/sliding bench and transfers the forces to the bench. Notably, if the test apparatus needs to accommodate tests with an angled bench, the impactor contact will need to on both sides of the Door. However the support structure for the door with a vertical pivot to allow rotation upon the angled impact cannot obstruct the impactor trajectory to the door and the connection means to the door after impact. For this reason some impactor structures are split vertically, having a left part and a right part to move past a central support structure of the door. Variations with different geometries are however possible. In the event of the apparatus not being used for angled impact testing, the impactor can contact the rear endo of the support structure as such contact at all points will be concurrent and there is not related rotation of the door required.
Honeycomb Structure: This is a special structure made of honeycomb sections of calibrated lengths and selected stiffness charecteristics attached in series or end to end. The structure has provisions such that honeycomb of different stiffness can be slid into it and the overall effective resistance of the structure can be varied based on the test requirements. The overall honeycomb structure is attached on one end to the impactor frame and the other end is free to contact the impact plate on the sliding bench. Some test structures will require stiffer honey comb to be crushed first and then later stages to have softer honey comb that could for example emulate in a car crash, the initial buckling of metals elements and then bending sheet metal and soft interiors. A special structure for enabling this sequence of honey comb crush is disclosed in U.S. 61/270,808.
Intruding Vehicle Door and Connection mechanisms: This one of the critical components of the sled that is used to represent the intrusion into the CRS space. This door is generic in nature and is attached to the Bench or the Target sled with special glides that attach to the door allowing it to be able to translate laterally in the direction of the movement of the two Sleds. In addition where testing is required for angled impact, the attachement of the Door slides are to the Target Sled and the attachment frame has a pivot attachment along the vertical axis approximately at the center of the door, which allows it to have different intrusion measures at different points along the horizontal direction on the door by allowing it to rotate about this vertical axis. The door is also equipped with connection mechanisms located on either side of the vertical pivot to connect the impactor to the door at the time of contact. Such connection means may be pairs of interlocking cones—one element of each pair attached to the impactor and the other attached to the door with a hinge or pivot mechanism. The Pivot mechanism will allow the connection means to be aligned to the corresponding cone on the Impactor. After contact and locking of one cone if ahead of the other in the case of an angled door, the pivot will allow the door to rotate about this pivot and its central pivot that supports it to the sliding mechanism, until the second pair(s) of cones interlock. Thereafter, the door will move in the direction of the Sled (and at an angle to the Bench if it is angled to the Sled). The motion of the door after the transitory rotational movement will be linear and will be at the speed of the impactor. Different generic vehicle doors can be made based on the class of the vehicle considered for testing. The door is attached to the sliding glides with a support that allows the door to intrunde in the space above the seat bottom. Therefore the support has an arm that is at least as long as the maximum intrusion anticipated for the door. At the rear of this support is connected the glides that slide on the Target sled or bench. The Door structure is locked to the supporting Bench or Target Sled ahead of contact of one of the pairs of locking cones connecting to the Impactor to ensure that the inertial loading of the Bench and Target Sled do not allow a relative velocity to develop between the Door structure and the Benchahead of the contact of the Impactor.
Collapsible CRS Attachment Anchors (Optional for special case for testing CRS in car designs with such arrangements): This component is similar to the tradition rigid LATCH anchors and are mounted on sliding internal or external sleeves on the lateral support beam. These anchors are maintained in their lateral position as required in the test design with collapsible members. These members may be designed to collapse upon the lateral force applied to them as a result of a lateral intrusion and the resulting forces on the CRS. Both anchors in some embodiments may be connected to the same force limiting member. One embodiment of the force limiting member can be a honey comb that is inside the lateral beam that supports the anchors and is rigidly attached to the beam at one end and the other end is attached to the slidable anchor sleeves. In addition the tether mount may also have load limiters.
Optional Braking Mechanism: The sled is equipped with a braking mechanism that resists the motion of the Target Sled/Bench after contact with the Impactor. In some cases the braking mechanism helps with limiting bounce of the Target Sled after initial contact with the honey comb. Another use for the brake is to stop the system within a required
Sequence of Operation: The sequence of operations of the sled are illustrated in FIGS. 13-16. The sequence starts at time zero, when the honeycomb structure of the bullet sled impacts the sliding bench on target sled. First stage of honeycomb starts to compress and the sliding bench starts to accelerate and transfers the load to the CRS, displacing it from the center line towards the impact. During the compression of the first stage of the honeycomb, the impactor contacts the door and locks with it, pushing it towards the CRS. After some lateral displacement door contacts the CRS and starts to push and crush the CRS. In some embodiments after 100 mm of door intrusion, second stage of honeycomb is enabled to crush and controls for the velocity of the impactor relative to the bench which in turn will control for the velocity and displacement of the intruding door. After the maximum intrusion the braking system on the Target sled and a Global decelerator may be employed to stop any further movement. Notably the Honeycomb compression and the Braking system if used controls for the velocity generated in the Target Sled to match with that of the velocity change as in a vehicle under crash conditions.

### Description of Operation of the Apparatus:

This invention provides a robust method to assess the performance of CRS while emulating the dynamic behavior of real world side impact crashes. The complex nature of the side impact kinematics causes inertial movement of the CRS upon initial contact of the vehicle and so would cause the ATD to be out of position at the time of intrusion contact. Depending on the design of the CRS and its attachment method to the vehicle (ISOFIX, LATCH, lap/shoulder and other mechanisms of future), this inertial movement will affect the head position at the time of intrusion contact. Therefore the designed test methods emulates both the inertial and intrusion effects on the performance of the CRS in a side impact mode. Moreover it provides the flexibility to measure performance of Car/CRS combinations of different car designs wherein the car designs have varying positions of the CRS latch anchors; stiffness of the car sides; and arrangements for impact related motion of the car Latch anchors and the tether anchors.

The test method is designed to perform as a comprehensive and universal side impact test method capable of emulating vehicle side impact collisions involving CRS. Importantly unlike previous methods, this test method is independent of the position of CRS and therefore provides results not only for designing of CRS but also for vehicles and related design parameters as noted above. The design parameters that the vehicle manufacturers can assess using this test method are for example: 1—width of the car; 2—the stiffness of side structures and the position of CRS relative to the doors; 3—the latch anchor and tether anchor lateral rigidity relative to the vehicle during impact conditions. No other CRS test method allows these degrees of freedom for vehicle design in their test methodology.

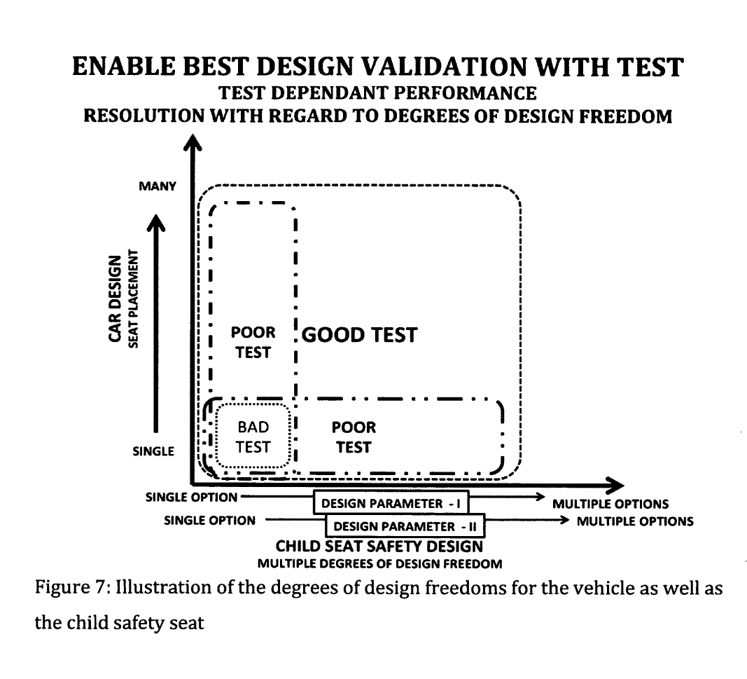

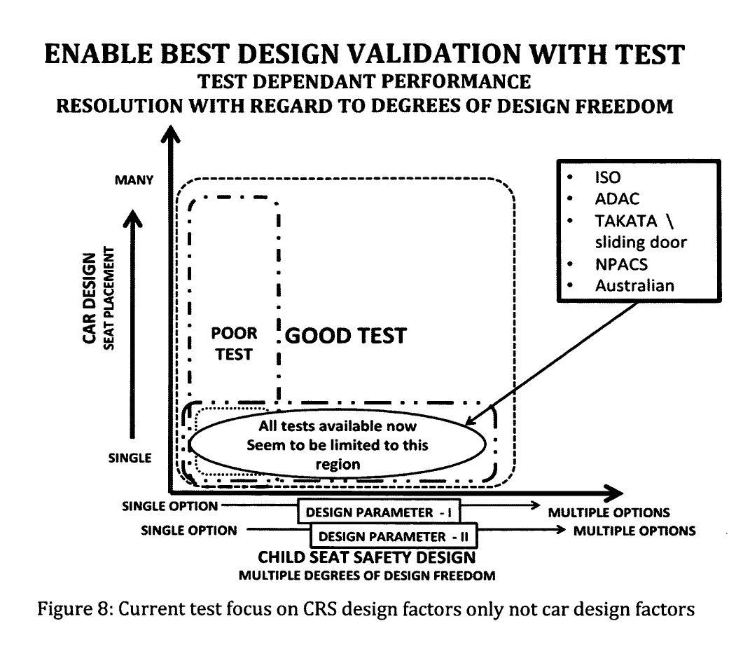

The performance of CRS depends on two key independent design factors—first, the degrees of freedom of vehicle manufacturers and secondly the degrees of freedom of the CRS manufacturers. A comprehensive test method would incorporate and distinguish the performance effect of these independent degrees of design freedom of both vehicle and CRS manufacturers in its method. FIG. 7 illustrates the degrees of design freedoms for the car as well as the CRS. Any test method can be classified as good test or poor test depending on the number of design parameters that are incorporated into that method. A bad test is one that incorporates the fewest design parameters of both the vehicle and CRS in its test procedure, while a good test is one that is capable of assessing the most design parameters as in the present invention that accommodates both the design parameters of the car and the CRS. In addition, the present invention is a test method that is capable of identifying critical degrees of design freedom for the child seat alone regardless of the design opportunities for the car. Available test methods nature when trying to incorporate different CRS design parameters such as intrusion and inertial loading performance assessment capability. FIG. 8 shows that available child seat testing methodologies seem to be confined to the region shown and therefore precludes the observation of value in better car design.

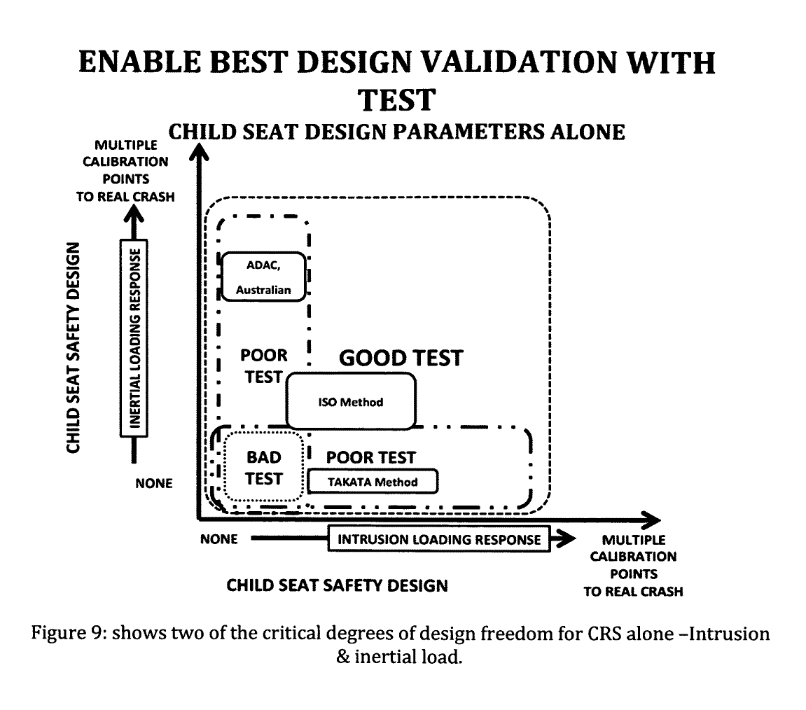

As shown in FIG. 9 the two critical degrees of design freedom for the child seat alone regardless of the design opportunities for the car are the loading response from intrusion and the loading response from inertial loads from the initial vehicle contact. The present invention provides a robust and simple approach to test performance concurrently on these two design dimensions of design freedom.

This test method is capable of replicating the main parameters observed by the struck vehicle during a side impact crash: first the acceleration of the struck vehicle and secondly the intrusion of the vehicle component on the struck side. By emulating the acceleration of the struck vehicle, the test is able to replicate inertial accelerations in the CRS relative to the vehicle, before contact with the intruding vehicle structure as observed in vehicle tests. Although the inertial accelerations may not be significant when compared to intrusion accelerations, any test method that does emulate inertial component of the acceleration will not be able to asses the performance with regard to the motion of the head of the ATD before the intrusion contact which can be the principal determinant of head injury. Better CRS designs will be able to mitigate this out of position head and reduce injury as a result, therefore making the present invention a more robust test and having greater resolution between CRS designs with regard to their actual performance in real world crashes. Finally the present invention offers a comprehensive, robust, repeatable and simple test.

There are several possible hardware embodiments of the present invention. The test hardware consists of a bullet sled and a target sled that incorporates the Bench and the CRS. A crushable and optional braking mechanism controls the transfer of momentum between the bullet and Target Sleds.

Some embodiments use the deceleration or HyGe Sled approach. Here, the test hardware consists of sled over a sled concept in which one sled carrying the impactor (bullet sled) moves independent to the other sled carrying a sliding bench (target sled) with a CRS attached and eventually impacting the sliding bench to generate the required inertial forces. Once the necessary forces are generated the impactor on the bullet sled makes contact with a generic vehicle door structure which is then pushed towards the CRS simulating the intrusion in a side impact collision. After the desired amount of intrusion is reached the bullet sled may be locked with the target sled and both may be stopped thereafter using the braking mechanism on the sled. The sled setup along with different components is illustrated in FIGS. 10,11. There are slight variations between the HyGe and the deceleration hardware. In both cases the Bullet sled can impact the Target Sled with the attached honey comb after the required initial velocity is reached by the Bullet Sled. In other embodiments of the HyGe hardware the contact of the Bullet Sled with the Target Sled can happen before the acceleration pulse of the HyGe sled is complete therefore the required honey comb may have different characteristics or the deceleration profile may as a result be different. These are additional design variables that could be harnessed in some cases. For example the HyGe pulse shape can be designed to define part of the acceleration profile. One such case is where the pulse has an acceleration above the force required to crush the honey comb the, the honey comb crushes and defines the acceleration of the sled. However when the acceleration of the pulse falls below that required for inertial load on the honey comb to crush it, the pulse shape will define the acceleration of the Bench. Therefore this is a second method of controlling a variable (or multistage) acceleration profile for emulating a real world crash. With a view to controlling the deceleration of the Bullet Sled relative of the Target Sled multiple stages of the honey comb with different compression characteristics or stiffness installed in series, may be used. Such multiple stages may be designed to change the deceleration of the Bullet Sled after the first calibration intrusion point is reached, so that the second intrusion level for zero velocity can be reached with the compression rate of the second stage. Multiple stages of honey comb can be used if multiple intrusion distance-intrusion velocities as observed in real world crashes need to be emulated for a more accurate performance result of the CRS/vehicle tested. For example the first stage honey comb attached to the impactor can begin crush to emulate the contact of the bullet vehicle with the vehicle sill to begin crushing the sill, the second stage of the honey comb can begin with emulation of the contact with the door, the third stage of the honey comb can begin with a predetermined intrusion distance of the door at a predetermined velocity at that distance, and the fourth stage of the honey comb can be the emulation of the crush of the CRS as the relative velocity between the Bench and the Impactor becomes zero. Notably the gradient of the intrusion distance-intrusion velocity curves are determined by the honey comb section being crushed at the time. Therefore the gradients can be controlled by choosing the appropriate density of honey comb material. Alternatively, with the HyGe Sled, the shape of the pulse can be used to define the gradient of the intrusion distance-intrusion velocity profile.

An alternative to using different honey comb densities is to use different cross section areas of the honey comb in each of the sections, to provide the required force.

Several embodiments of the present invention are possible with a tradeoff of simplicity for precision of the test results when compared to the emulated real world crashes.

A simple embodiment of the present invention uses four calibration data points, that can make the Sled test reasonably representative of a typical vehicle test. The four calibration points are:
1. Velocity of the Impactor at the time of contact with the bench/target sled, which is representative of the velocity of the bullet vehicle before contact with target vehicle;
2. Intrusion distance at a predetermined intrusion velocity (or a velocity at a predetermined intrusion distance);
3. Time lag for the above intrusion distance-velocity combination to be reached after the initial vehicle contact; and
4. Maximum intrusion at zero intrusion velocity.

A second embodiment of the present invention has the following calibration points:
1. First calibration point as the velocity of the impactor at the time of contact with the vehicle sill.
2. Second calibration point as the Impactor relative velocity with the bench at the time of contact of the impactor with the door structure.
3. Third calibration point as the relative velocity of the Impact/Door structure with the bench at a predetermined intrusion distance of the door structure.
4. The intrusion distance of the door structure at zero impactor/door velocity relative to the bench.

Additional calibration points can be added for example to control the rate relative deceleration of the intrusion into the CRS space.

The sled method is designed to provide different calibration points so as to be able to configure the test for specific impact conditions. The first calibration point of the initial contact of bullet sled with the target sled is achieved by controlling the velocity of the bullet sled at the time of the Honey Comb contact with the Target Sled. This calibration also allows to test for responses due to contact with different vehicles at different speeds.

In the simple embodiment noted there are two additional calibration points: One predetermined intrusion distance with a predetermined velocity and time of occurance; and the Distance of Maximum intrusion (zero velocity). The time for the contact of the impactor with the vehicle door can be controlled by controlling the distance between the impact ro and the door. The further apart they are the later the impactor contacts the door and closer they are sooner is the contact. This control of spacing allows for controlling the start of intrusion into the CRS space and therefore the time of the first of these calibrated intrusion-distance/intrusion velocity point desired. The stiffness of the first stage of the honey comb will determine the required intrusion velocity at the required intrusion distance.

The second stage of the honey comb will determine the maximum intrusion distance at zero velocity.

In the second embodiment of the invention noted after raising the Impactor to the required first calibration point of the relative velocity of the impactor to the Bench, the next stage emulating sill crush (second calibration point) can be executed with the crush of the first honey comb section. The next stage emulating the door intrusion to a predetermined depth (third calibration point) can be implemented with the second stage of the honey comb. The next stage emulating the final stage of intrusion which brings the target and bullet vehicles to a common velocity can be emulated with the final stage of honey comb. Notably the softest honey comb section will always crush first and this is a constraint on the settings that can be chosen for each of the sequential stages of crush.

However there are devices available in the background art that can overcome this constraint by protecting the softer honeycomb section till a later stage of crush (PCT/US 2010/000237). For example the sill which is crushed before the intrusion of the door often represents a stiffer resistance. In other cases the sill crush can happen concurrently with the initial intrusion of the door but offer a high resistance after which the door crush can offer a softer resistance. Therefore with such a structures to be emulated, the First section of the honey comb needs to be stiff and thereafter a softer section of honey comb will need to be crushed. This will be possible with such a mechanism.

With any of the above embodiments yet another stage of honey comb may be added to calibrate the initial relative velocity of the Impactor to the Bench after contact of the Impactor with the Bench and subsequent acceleration of the Bench with such a stage.

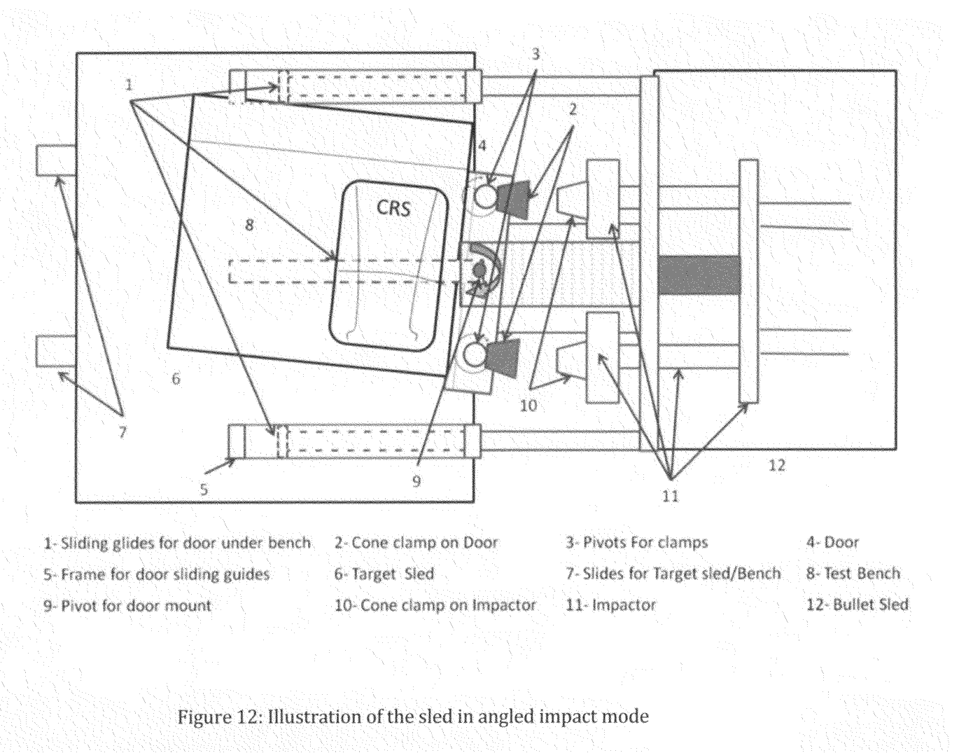

In addition to providing multiple calibration points for robust testing, the proposed test method can also emulate various impact conditions. The sled can be used for pure lateral impacts, angled impacts and pole impacts. For achieving angled and pole impacts, the test bench on the target sled in oriented to the desired angle and the door is placed perpendicular to the seat. This causes the door to be at an angle to the impactor. Upon contact with the bullet sled, the target sled starts to translate and since the bench is attached at an angle on the platform the CRS experiences longitudinal forces in addition to the lateral forces. Also due to the angled orientation of the door with respect to impactor, the ends of the door contact the impactor at different times and as a result different intrusion values are obtained in the frontend and backend of the door. To achieve this variation the door is mounted on a central axis to a support structure that is attached to glides on the bench/target sled. The center axis will accommodate for the uneven intrusion that would result due to the angled contact with the door. The details illustration of the angled impact is provided in FIG. 12.

As mentioned in the above paragraph the setup can be used in both the HYGE and the deceleration sled systems with relatively minor modifications. in the attachment of vehicle generic door and the honeycomb structure. In a deceleration sled system, the bullet sled consists of impactor alone while the sliding target sled consisting of the bench with CRS attached is stationary. In addition, the honeycomb structure and the vehicle door are attached to the target sled. With the HYGE sled system, the entire setup consisting of sliding bench, vehicle door and a fixed impactor are on a translating platform. As the platform accelerates, the sliding bench moves towards the impactor and contacts the honeycomb on the impactor. As the bench and CRS starts to translate the door moves along with it and upon contact of the impactor, it movies independent of the bench emulating the intrusion. Although door can be attached to either the bench or the target sled, attaching it to the target sled provides the flexibility to use a narrower bench to evaluate performance variations due to different attachment conditions.

Another critical component that contributes to the sled design is the ratio of mass of the bench and the target sled. This ratio influences the precision of the results due to the transfer of the force from the impactor into the moving mass of bench and target sled and then to the CRS. If the force that is applied to the CRS by the intruding door is neglected, the force accelerating the Bench/targetsled/CRS is solely due to the crushing honey comb (or in some cases the pulse of the HyGe input if concurrent with the impact). However, if this force on the CRS is significant compared to the force through the Honeycomb, the acceleration will no longer be determined by the honeycomb alone but by the crush rate of the CRS as well. The stiffer the CRS the worse this effect becomes. Furhter if the mass of the Target Sled. Bench/CRS is low this effect becomes even more pronounced as the inertial mass is lower compared to the force through the CRS contact with the door. Therefore a solution is to have a high mass sled that dwarf the possible forces through the CRS/door contact.

Finally while the present invention uses honey comb as a means for transferring forces, other equivalent mechanisms such as bending plates can be used.

What is left for calibrating the Present invention is the use of real world crash data to define the several calibration points available in the test methodology.

Defining the Calibration Points of the Sled Test Method Using Data from Real World Crashes

A sled test method is only good if it can emulate the responses as experienced in the real world crashes. Therefore, it is important to use data from real world crashes as a reference to compare and calibrate the sled output to it. For this particular calibration of the sled test method, available test data from NHTSA database was collected. For each of the test, data from different vehicle accelerometers, CRS and dummy instrumentations were collected. In order to generate the intrusion velocity vs. intrusion profiles data from the door mounted accelerometers were compared with that of the vehicle rear sill mounted accelerometers. The velocity and displacement values were obtained by integrating and double integrating the acceleration values respectively.

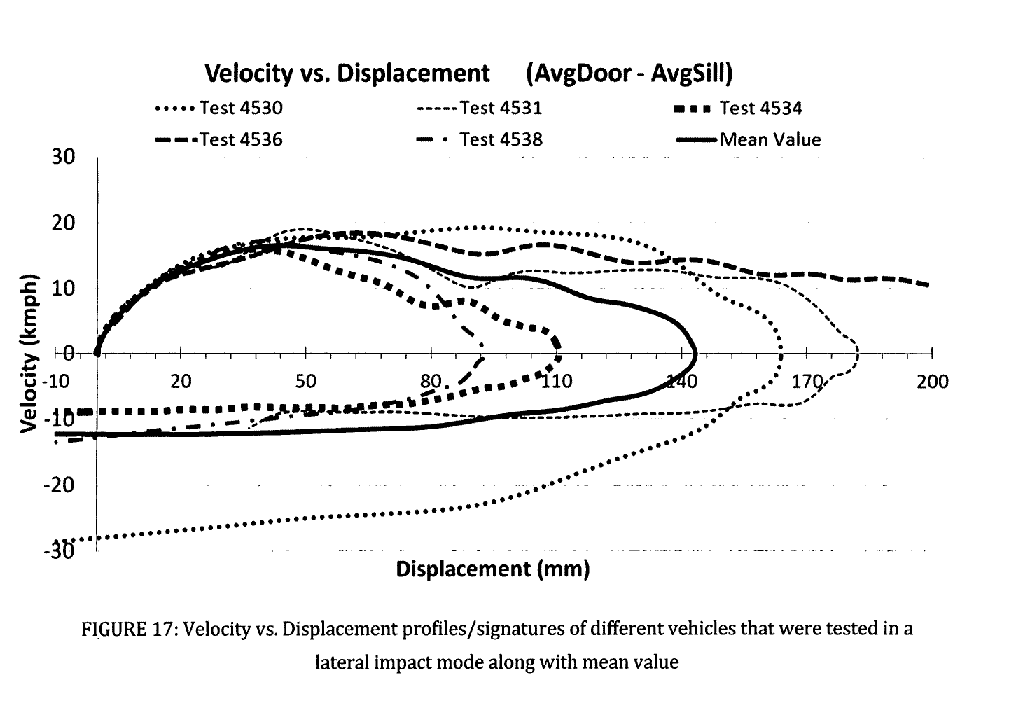

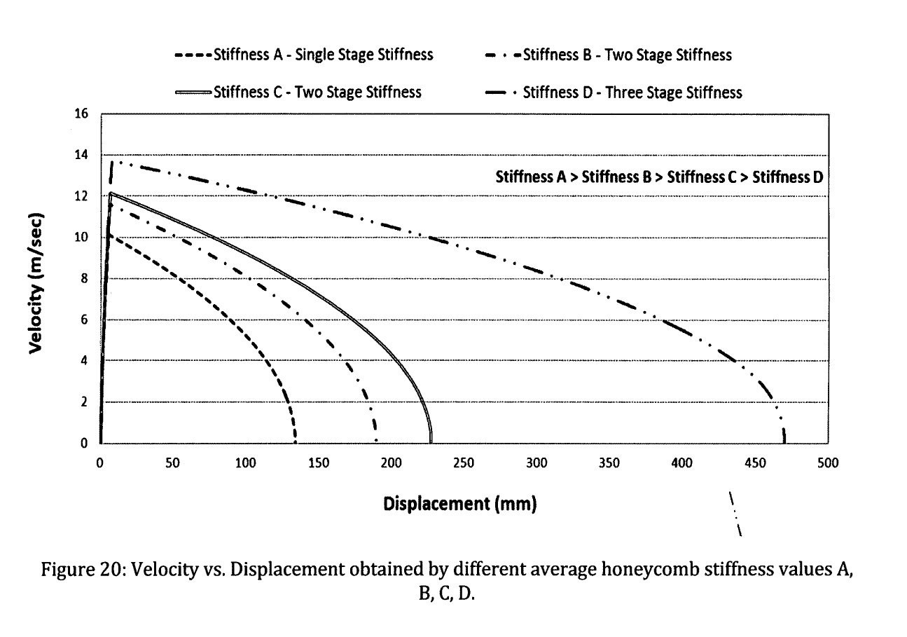

FIG. 17 is the graph that provides profiles of the intrusion velocity with respect to intrusion for different vehicles involved in side impact collision. Different vehicles have different performance in a crash and so the velocity-displacement signatures are diverse for each vehicle. In order to better represent these variations in a sled test, it is a feature of the present invention to enable the creation of reference points for each class of vehicle (Compact PC, Midsize PC, Full-size PC, SUV, minivan, etc). As noted earlier the density and lengths of the honey comb stages will define the gradient of the intrusion distance-Intrusion velocity “signatures” of each of several classes of vehicles. These gradients can be emulated by multi stage honey comb structures and in these embodiments—two or more stages of honey comb sections that can be defined to create similar gradients as in the vehicle data for intrusion distance-intrusion velocity as shown in the FIG. 20. Defining and calibrating sled test for a specific vehicle class will help in designing child restraints that are more effective in preventing injuries to children in each vehicle class. A median or weighted mean for vehicle populations for example could be used for the entire vehicle population.

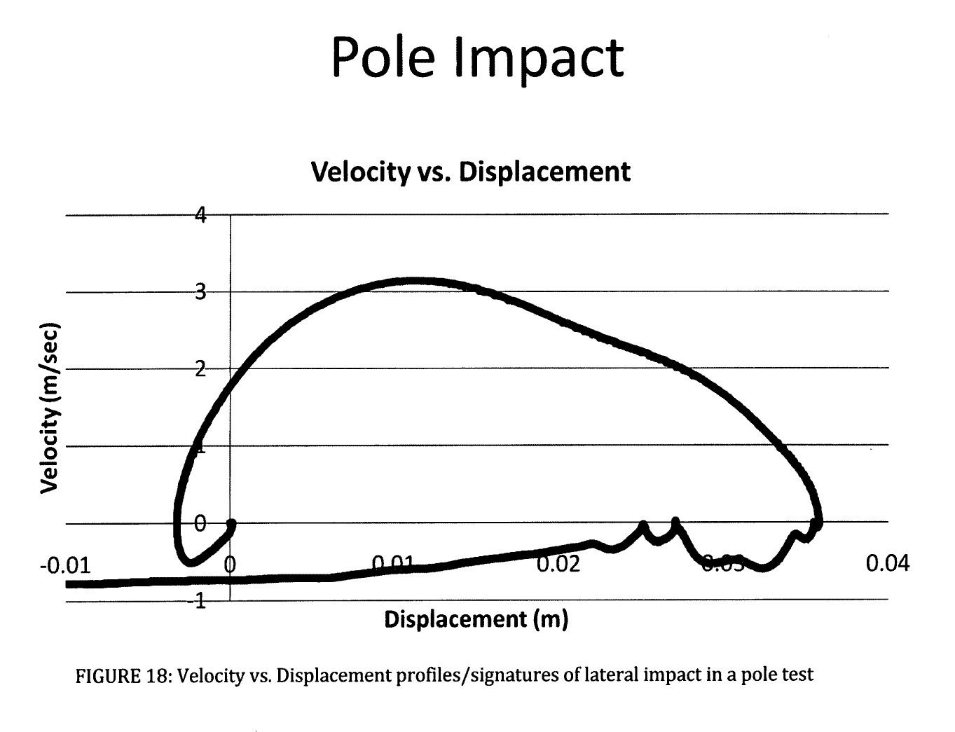

In addition to the variations observed in the vehicle class, different impacts produce different velocity-displacement profiles/signatures. For example in pole impacts, due to the narrow and concentrated nature of impact, the velocity-displacement profile is different from that of a typical side impact crash. FIG. 18 shows the velocity-displacement profile of the rear seat of a vehicle involved in a typical pole impact. It can seen that, in the initial stage of the contact the intrusion is negative in direction indicating that instead of the vehicle component intruding into the occupant space it is moving away. This primarily due to the narrow region of the impact that causes the other surrounding areas of the vehicle structure to crumple away initially before intruding into the occupant space.

In order to demonstrate the capability of the sled to differentiate these variations observed in real world vehicle crashes, a simulated calculation was done in using simple lumped mass method to calculate the velocities and accelerations. Different critical components of the sled were considered with an assigned mass and inserted in the model. Key reference points are chosen for the representation of the impact conditions. First the vehicle contact velocity, second the time to get to a given intrusion and the related velocity and thereafter one or more intrusions that are calibrated to corresponding velocities.

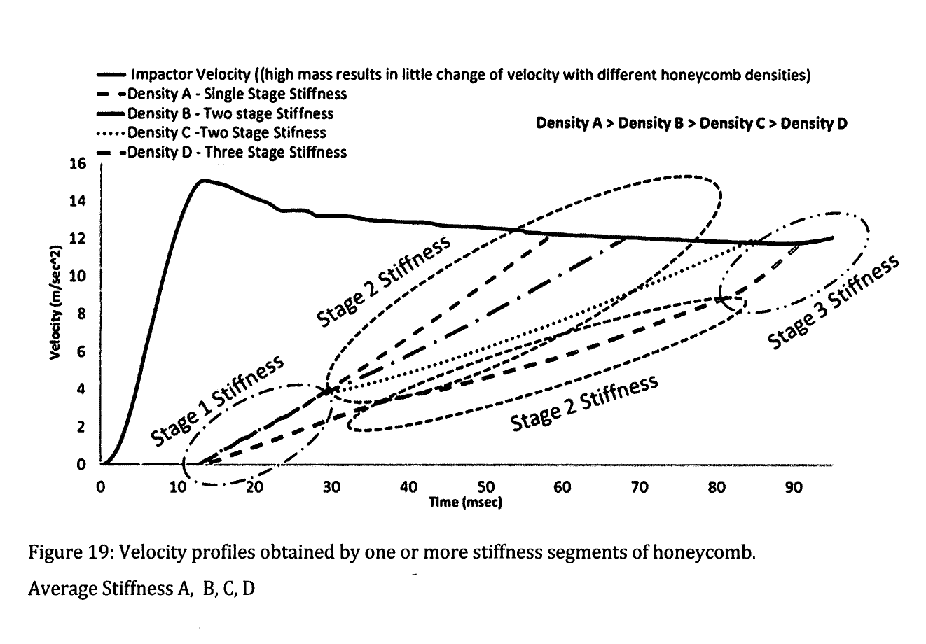

Applying the laws of motion, the velocity and displacement profiles for a single vehicle case. The input reference values for the model were based on a full vehicle test and generic honeycomb stiffness values were used for controlling the intrusion movement. FIG. 19 provides the different velocity-time profiles of the bench and the impactor while adjusting for different starting position of the impactor with respect to the door and different stiffness levels for the one or more honey comb stages in the honey comb structure. This demonstrates the capability of the proposed sled design invention to control for the variation in the outcome.

The other important key calibration points of the sled are the maximum velocity and its associated intrusion value and the maximum intrusion value. FIG. 20 shows different velocity-displacement profiles of intrusion for the variations in the velocity-time profiles shown in FIG. 19. The variations in velocity-displacement profile are obtained by varying the stiffness of the honeycomb structure. This provides the capability to control for different kinds of side impacts like vehicle to vehicle, pole imparts and angled impacts.

### CONCLUSIONS, RAMIFICATIONS & SCOPE

It will become apparent that the present invention presented, provides a new paradigm for implementing key safety features comfort and convenience features for occupants in vehicles.

1. An apparatus for testing the side impact performance of a Child Restraint System (CRS) comprising:
A support structure
An Impactor slidably attached along an impact direction of motion to the support structure and comprising at least one of a first part of detachably attachable clamp;
A Target Sled slidably attached to the support structure along the impact direction, further comprising support means for a Bench;
A Bench with a support means for a CRS;
A CRS supported by the Bench;
A door structure slidably attached to the Bench along the impact direction, further comprising at least one of a second part of the detachably attachable clamp aligned to the at least one first part the detachably attachable clamp and wherein said door structure is locked to the Bench until contact of a predetermined one of the first part of the detachably attached clamps to the corresponding second part of the predetermined one of the detachably attachable clamps;
a control mechanism for the regulation of the relative velocity of the Target Sled with regard to the Impactor with a plurality of calibration points;
enabled to measure both an inertial loading of the CRS resulting from the impact on the vehicle and a contact loading as a result of the intrusion of a door towards the CRS, with a plurality of calibration points for the relative velocity of the Impactor with regard to the Bench.

2. An apparatus as in claim 1, wherein the control mechanism for the regulation of the Target Sled with regard to the Impactor comprises a compressible structure with a plurality of compressible sections arranged in series such that one of: a first end of the compressible structure is attached to the bench and the second end of the compressible structure is enabled to contact the Impactor; and a first end of the compressible structure is attached to the Impactor and the second end of the compressible structure is enabled to contact the bench upon a predetermined relative motion of the Impactor with regard to the bench.

3. An apparatus as in claim 1, wherein the Impactor is mounted on a HyGe Sled.

4. An apparatus as in claim 2, wherein, the compressive properties of each of the sections of the compressible assembly are chosen to enable the Impactor upon sliding towards the Bench at a predetermined velocity to crush the crushable assembly in a sequential order of stiffness of its sections to reach predetermined calibration points of the bench that are each at least one of: distance/velocities; distance/time; and velocity/time combinations in actual car crashes or representative measures of such actual car crashes.

5. An apparatus as in claim 4, wherein at a predetermined distance of crush of the first stage of the crushable assembly the first part of the at least one detachably attachable clamp attaches to the second part of the at least one detachably attachable clamp, thereby moving the door with it, and wherein the second stage of the crushable assembly begins to crush after the door structure moves by a predetermined distance, and thereafter a third stage of the crushable assembly crushes until the bench attains a velocity of the Impactor wherein the relative velocity of the bench is zero.

6. An apparatus as in claim 3 wherein a pulse of the HyGe Sled is used for the first calibration point of the apparatus.

7. An apparatus as in claim 1 wherein the Bench attached to the CRS is angled to the impact direction thereby offering an angled impact to the CRS.
